(19) United States
(12) Patent Application Publication
(10) Pub. No.: US 2021/0122579 A1
(43) Pub. Date: Apr. 29, 2021

(54) GAP FILLER FOR RECIPROCATING FLOOR SLAT CONVEYOR

(71) Applicant: Keith Manufacturing Co., Madras, OR (US)

(72) Inventors: Daniel Jackson, Madras, OR (US); John Cook, Madras, OR (US)

(73) Assignee: Keith Manufacturing Co., Madras, OR (US)

(21) Appl. No.: 17/079,460

(22) Filed: Oct. 24, 2020

Related U.S. Application Data
(60) Provisional application No. 62/925,515, filed on Oct. 24, 2019.

(51) Int. Cl. B65G 25/06

(52) U.S. Cl. CPC B65G 25/065

(57) ABSTRACT

For use in a reciprocating floor slat conveyor system having formed slats made of steel, a gap filler for sealing the gaps between side-by-side steel slats includes a portion that extends upwardly into the gap, and a lower portion that is connected to one of the side-by-side slats.

### TECHNICAL FIELD

This design relates to reciprocating floor slat conveyors.

### BACKGROUND

Reciprocating floor slat conveyors are well-known. They consist of a series of side-by-side floor slats that are all moved in one direction at the same time. This moves or conveys a load that rests on the floor slats. Then, a lesser number of floor slats is moved in the opposite direction, sliding underneath the load. This is commonly done in sets of three, or in other words, one third of the slats are moved in the opposite direction, in sequence, until all are returned to their initial position. Moving a lesser number of slats during the return sufficiently reduces friction between the slats and the load above, such that the load holds its position during the return. Then, the slats are moved again, all at the same time, to further carry the load, and so forth, with the sequence just described being repeated until the load is moved off the reciprocating floor slat conveyor. Systems of this kind are often installed in trailers for hauling and unloading bulk materials, although there are also many other kinds of applications, including stationary applications.

The reciprocating floor slats are commonly made from extruded aluminum. However, there is a need and market for steel floor slats.

The design disclosed here was created to fill the elongated space or “gap” between steel floor slats.

### SUMMARY

For use with a reciprocating floor slat conveyor that has reciprocating floor slats that are formed from steel, a gap filler that fills the space in-between side-by-side slats.

The slats in the conveyor will have a lengthwise gap between adjacent side-by-side steel slats that enables the slats to move together, or in reciprocating fashion, according to conventional operation of the conveyor. The gap filler includes an upper portion that extends upwardly into the lengthwise gap. A lower portion of the gap filler, connected to the upper portion, is wrapped around a lower side edge of one of the side-by-side steel slats.

The above summary will be better understood upon review of the following description which is to be read in conjunction with the illustrated details of the drawings.

### BRIEF DESCRIPTION OF THE DRAWINGS

The accompanying drawings are described as follows:

FIG. 1 is a cross-sectional view of a series of side-by-side reciprocating floor slats;

FIG. 2 is an enlarged view of one floor slat of the overall floor slat configuration shown in FIG. 1;

FIG. 3 is a cross-sectional view of a subdeck component of the floor slat configuration shown in FIG. 1;

FIG. 4 is a cross-sectional view of floor bearing components of the floor slat configuration shown in FIG. 1;

FIG. 5 is a cross-sectional view of a “gap filler” component of the floor slat configuration shown in FIG. 1; and

FIG. 6 is a view like FIG. 5, but without dimensions.

### DETAILED DESCRIPTION

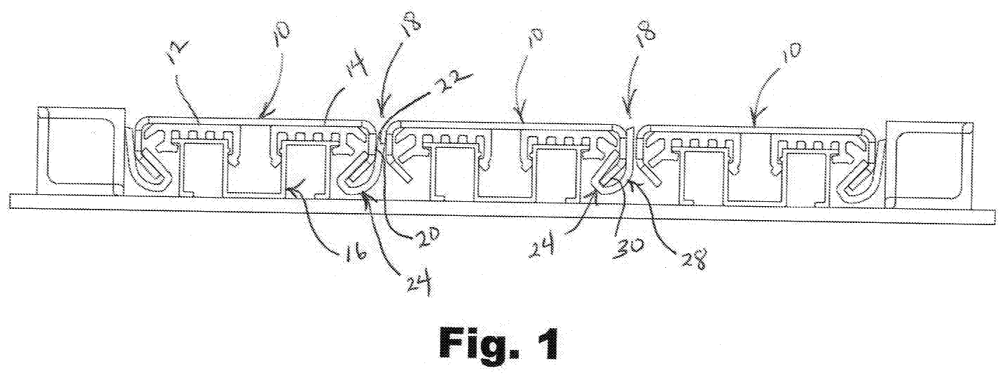

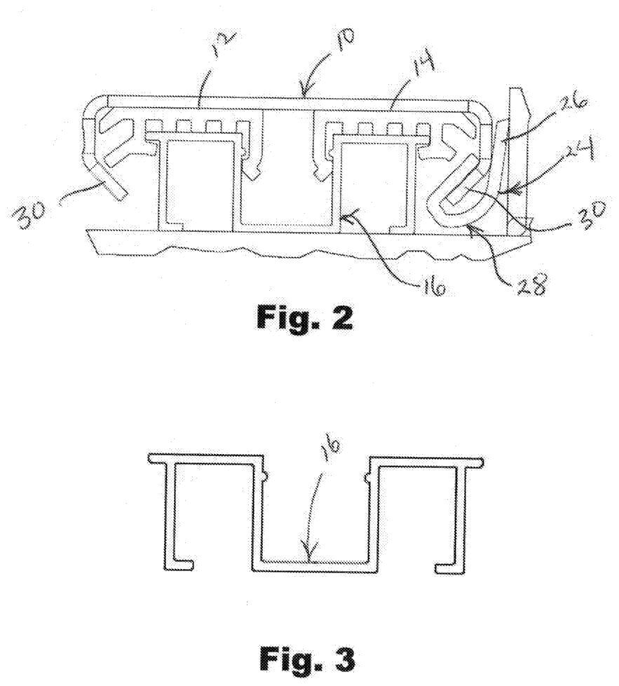

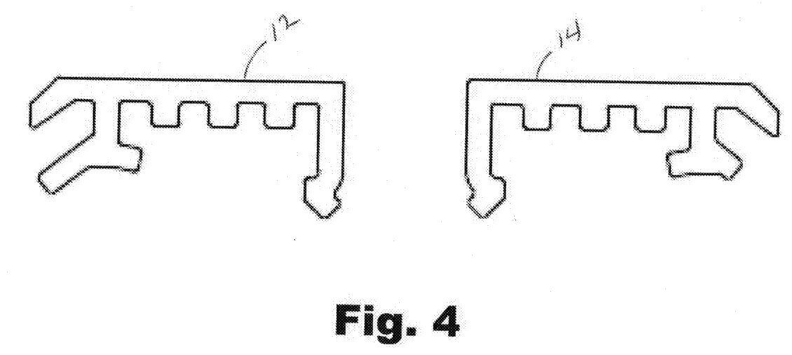

Referring first to FIG. 1, each floor slat is generally identified by reference numeral 10. It is envisioned that the floor slat 10 will be made of formed steel having the shape illustrated in the drawings.

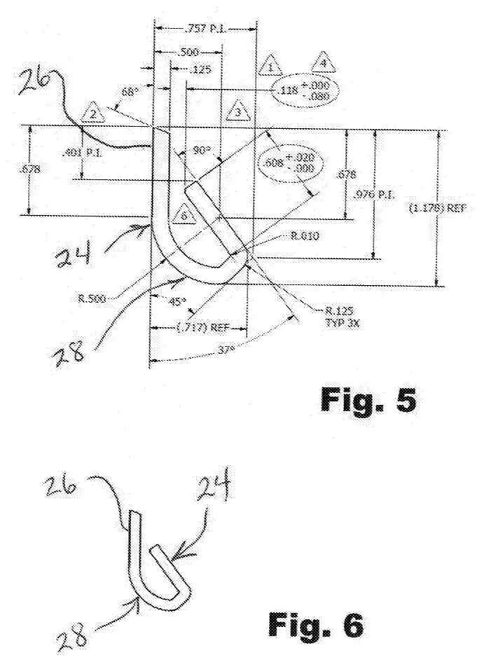

Referring now to FIG. 2, each floor slat rests upon a pair of bearings 12, 14, which further rest upon a subdeck component, indicated generally at 16. As can be seen in FIG. 1, the floor slats are installed so that a small or narrow gap (at the position indicated by reference numeral 18) will exist lengthwise between the sides 20, 22 of the slats. This gap is filled by the component (“the gap filler”) indicated generally at 24 in FIGS. 5 and 6.

The narrow gap 18 between the floor slats is filled by an upper portion 26 of the gap filler 24. The lower portion of the gap filler 24, indicated generally by reference numeral 28 in FIGS. 5 and 6, is wrapped around a lower side edge 30 of the steel floor slat (see, e.g., FIG. 2).

Exemplary dimensions of the gap filler 24 are provided in FIG. 5. While these dimensions may vary, it is envisioned that they will be sized so that the lower portion 28 of the gap filler can snap-fit onto the lower side edge 30 of the steel floor slat. This would allow the gap filler to be preinstalled at the place of floor slat manufacture and then shipped, installed, to the end user.

When the floor slats 10 are installed in the manner illustrated in FIG. 1, the upper portion 26 of the gap filler 24 vertically fills gap 18 and is captured in place. It is envisioned that the gap filler 24 can be made from different materials ranging from metal (aluminum, for example) or high-density plastic. This is an ongoing matter of development and test.

The foregoing is a design disclosure that is made for the purpose of establishing a priority patent application filing date. It is to be understood that the design is under development and test and may change as the design is further developed. The foregoing is not intended to limit patent protection. To the extent patent protection is limited, all limits on patent protection are defined by the patent claim or claims that follow.

What is claimed is:

1. For use with a reciprocating floor slat conveyor, said conveyor having a plurality of reciprocating floor slats that are formed from steel, said floor slats being installed with a lengthwise gap between adjacent side-by-side steel slats, a gap filler member comprising:
an upper portion that extends upwardly into said lengthwise gap; and
a lower portion, connected to said upper portion, wherein said lower portion is wrapped around a lower side edge of one of said side-by-side steel slats.
